(19) United States
(12) Patent Application Publication
(10) Pub. No.: US 2013/0332608 A1
(43) Pub. Date: Dec. 12, 2013

(54) LOAD BALANCING FOR DISTRIBUTED KEY-VALUE STORE

(71) Applicants: Kenta SHIGA, Singapore (SG); Wujuan LIN, Singapore (SG)

(72) Inventors: Kenta SHIGA, Singapore (SG); Wujuan LIN, Singapore (SG)

(73) Assignee: HITACHI, LTD., Tokyo (JP)

(21) Appl. No.: 13/489,897

(22) Filed: Jun. 6, 2012

(51) Int. Cl. G06F 15/173

(52) U.S. Cl. 709/226

(57) ABSTRACT

According to one embodiment of load balancing, a system comprises a plurality of nodes being configured to allow input/output (I/O) access to a plurality of data, each data being accessed as a value via a unique key which is associated with the value as a key-value pair, the data being distributed and stored among the plurality of nodes based on hush values of the keys. Each node includes an I/O module to record a number of I/O accesses to each key of a plurality of keys associated with the plurality of data as values, respectively, to form key-value pairs. If resource utilization of a node exceeds a preset threshold, then the node is an overloaded node, and the overloaded node migrates out a part of the key-value pairs in the overloaded node in order to reduce the resource utilization to a level below the preset threshold.

### BACKGROUND OF THE INVENTION

The present invention relates generally to storage systems and, more particularly, to load balancing for a distributed key-value store.

Recently there are obvious demands for technologies which enable enterprises to analyze a large amount of data and utilize the result of the analysis to provide customers with new services. Such data might be distributed not only within one data center but also across a plurality of data centers. KVS (Key-Value Store) is one of the new types of storage to store such a large amount of data. KVS is a simple database which enables users to store and read data (also called values) with a unique key.

Generally data are distributed to a plurality of KVS nodes based on hash values of keys. US2009/0282048A1 discloses a way to distribute key-value typed data across a plurality of KVS nodes only based on hash values of keys. However, the loads of KVS nodes are not balanced due to imbalance of the number of accesses to data as well as the amount of data. As a result, resources (CPU, HDD and so on) of all KVS nodes are not fully utilized and total performance of KVS is not improved linearly. To solve this problem, KVS may rebalance data across a plurality of KVS nodes based on the amount of data. However, if access frequency to each key varies, rebalancing data based on the amount of data does not always balance the load of KVS nodes.

Japanese Laid-open Patent Application H06-139119 discloses a way to manage access frequency of each storage device storing data table in a system, by dividing table data with high access frequency for one processor with a corresponding storage device, and allocating divided data to other processors with corresponding storage devices, according to predefined rules. More specifically, when one of three processors has high access frequency above a predefined threshold, it divides the data into three so that data volume is uniform, and transfers two divided data, respectively, to the other two processors.

### BRIEF SUMMARY OF THE INVENTION

Exemplary embodiments of the invention provide a KVS which rebalances data across a plurality of KVS nodes based on the number of accesses to keys. The techniques of the present invention can be used as a basic approach to rebalance key-value data which are distributed across a plurality of KVS nodes even though access frequencies to data are not balanced. As a result, resource utilization of all nodes can be maximized and performance is improved linearly if the number of KVS nodes is increased.

In accordance with an aspect of the present invention, a system comprises a plurality of nodes being configured to allow input/output (I/O) access to a plurality of data, each data being accessed as a value via a unique key which is associated with the value as a key-value pair, the plurality of data being distributed and stored among the plurality of nodes based on hush values of the keys each of which is associated with one of the plurality of data as a value. Each node includes an I/O module to record a number of I/O accesses to each key of a plurality of keys associated with the plurality of data as values, respectively, to form the key-value pairs. If resource utilization of one of the nodes exceeds a preset threshold, then the node is an overloaded node, and the overloaded node migrates out a part of the key-value pairs in the overloaded node.

In some embodiments, the overloaded node is configured to: calculate a number of I/O accesses to be migrated out from the overloaded node; and determine a key range in the overloaded node to be migrated out based on the calculated number of I/O accesses to be migrated out from the overloaded node in order to reduce the resource utilization to a level below the preset threshold. The overloaded node is configured to: request a target node to create a virtual node, which is responsible for the key range to be migrated, in the target node; and migrate key-value pairs in the determined key range to the target node. Each of the plurality of nodes includes a number of accesses calculation module which is configured, in response to a request from the overloaded node, to calculate a number of I/O accesses the node can accommodate from the overloaded node and provide the calculated number of I/O accesses to the overloaded node. The overloaded node is configured to select a target node, from the plurality of nodes other than the overloaded node, which can accommodate a largest number of I/O accesses from the overloaded node.

In specific embodiments, one of the nodes is a responsible node configured to collect resource utilization and a number of accesses of each of the plurality of nodes. The responsible node has a load balancing module which requests the overloaded node to execute the migration process to migrate out a part of the key-value pairs in the overloaded node if the resource utilization of a node exceeds the preset threshold. The load balancing module of the responsible node is configured to calculate a number of I/O accesses to be migrated out from the overloaded node; select a target node, from the plurality of nodes other than the overloaded node, which can accommodate a largest number of I/O accesses from other nodes; and request the overloaded node to execute migration of a part of the key-value pairs to the target node in order to reduce the resource utilization to a level below the preset threshold. The overloaded node has a key-value pairs migration module configured, in response to the request from the responsible node to execute migration, to: determine a key range in the overloaded node to be migrated out based on the calculated number of I/O accesses to be migrated out from the overloaded node in order to reduce the resource utilization to a level below the preset threshold; request the target node to create a virtual node, which is responsible for the key range to be migrated, in the target node; and migrate key-value pairs in the determined key range to the target node.

In some embodiments, the plurality of nodes are divided into a plurality of groups of multiple nodes. The responsible node is a node in each group configured to collect resource utilization and a number of accesses of each of the multiple nodes in the group. If the resource utilization of all nodes in the group exceeds the preset threshold, then the group is an overloaded group having overloaded nodes, and the responsible node in the overloaded group has a group load balancing module configured to execute a migration process to migrate out a part of the key-value pairs in at least one overloaded node in the overloaded group. The group load balancing module of the responsible node in the overloaded group is configured to: calculate a number of I/O accesses to be migrated out from the overloaded group; select a target group, from the plurality of groups other than the overloaded group, which can accommodate a largest number of I/O accesses from the overloaded group; select the at least one overloaded node in the overloaded group; determine a key range in each selected node of the selected at least one overloaded node to be migrated out based on the calculated number of I/O accesses to be migrated out from the overloaded group; request the responsible node of the target group to create a DHT overlay of virtual nodes in target nodes in the target group which are responsible for the key range of each selected node to be migrated; and request the selected at least one overloaded node to execute migration of a part of the key-value pairs to the target group in order to reduce the resource utilization of the overloaded group to a level below the preset threshold.

In specific embodiments, the responsible node of the target group has a group DHT (Distributed Hash Table) routing module configured, in response to a request from the group load balancing module of the responsible node in the overloaded group to create a DHT overlay, to: determine a key range in each target node of the target group to receive key-value pairs to be migrated from the overloaded group based on the key range in the selected at least one overloaded node determined by the group load balancing module of the responsible node of the overloaded group; and request each target node to create a virtual node, which is responsible for at least a portion of the key range of the selected at least one overloaded node to be migrated, in the target node.

In some embodiments, the group load balancing module of the responsible node in the overloaded group is configured, after executing the migration process to migrate out a part of the key-value pairs in at least one overloaded node in the overloaded group, to rebalance load among the plurality of nodes in the overloaded group.

Another aspect of the invention is directed to a load balancing method for a system which includes a plurality of nodes being configured to allow input/output (I/O) access to a plurality of data, each data being accessed as a value via a unique key which is associated with the value as a key-value pair, the plurality of data being distributed and stored among the plurality of nodes based on hush values of the keys each of which is associated with one of the plurality of data as a value. The method comprises: recording a number of I/O accesses to each key of a plurality of keys associated with the plurality of data as values, respectively, to form key-value pairs; and if resource utilization of one of the nodes, as an overloaded node, exceeds a preset threshold, then migrating out a part of the key-value pairs in the overloaded node.

In some embodiments, the method further comprises calculating a number of I/O accesses to be migrated out from the overloaded node; and determining a key range in the overloaded node to be migrated out based on the calculated number of I/O accesses to be migrated out from the overloaded node. The method further comprises requesting a target node to create a virtual node, which is responsible for the key range to be migrated, in the target node; and migrating, by the overloaded node, key-value pairs in the determined key range to the target node.

These and other features and advantages of the present invention will become apparent to those of ordinary skill in the art in view of the following detailed description of the specific embodiments.

### BRIEF DESCRIPTION OF THE DRAWINGS

FIG. 1 is an exemplary diagram of an overall system in which the key-value store of the present invention may be implemented according to the first embodiment.

FIG. 2 is a block diagram illustrating components within a Node 1 according the first embodiment of the invention.

FIG. 3 shows a high level overview of a logical architecture of the system according to the first embodiment.

FIG. 4 shows another high level overview of a logical architecture of the system to illustrate conflict across a plurality of load balancing tasks.

FIG. 5 shows an example of a DHT Routing Table maintained in a Node.

FIG. 6 shows an example of a user created Key-Value Table.

FIG. 7 shows an example of a Virtual Node Table.

FIG. 8 shows an example of a Threshold of Resource Utilization Input Screen.

FIG. 9 is an example of a flow diagram illustrating the exemplary steps of Virtual Node Creation Processing.

FIG. 10 is an example of a flow diagram illustrating the exemplary steps of I/O Processing.

FIG. 11 is an example of a flow diagram illustrating the exemplary steps of Load Balancing Processing.

FIG. 12 is an example of a flow diagram illustrating the exemplary steps of Number of Accesses Calculation Processing.

FIG. 13 is a block diagram illustrating the components within a Node according to the second embodiment.

FIG. 14 shows an example of a Resource Utilization Table.

FIG. 15 is an example of a flow diagram illustrating the exemplary steps of Resource Utilization Monitoring Processing.

FIG. 16 is an example of a flow diagram illustrating the exemplary steps of Load Balancing Processing according to the second embodiment.

FIG. 17 is an example of a flow diagram illustrating the exemplary steps of Key-Value Pairs Migration Processing.

FIG. 18 is an exemplary diagram of an overall system according to the third embodiment of the invention.

FIG. 19 is a block diagram illustrating components within a Node according to the third embodiment.

FIG. 20 shows a high level overview of a logical architecture of the system according to the third embodiment.

FIG. 21 illustrates the creation of a new virtual node in a group in the system of FIG. 20.

FIG. 22 shows an example of a Group DHT Routing Table maintained in a responsible node.

FIG. 23 shows an example of a DHT Overlay Table.

FIG. 24 shows an example of a DHT Overlay ID Input Screen.

FIG. 25 is an example of a flow diagram illustrating the exemplary steps of Group Load Balancing Processing.

FIG. 26 is an example of a flow diagram illustrating the exemplary steps of DHT Overlay Creation Processing.

FIG. 27 is an example of a flow diagram illustrating the exemplary steps of Rebalancing Processing.

FIG. 28 shows an example of Master Node Input Screen.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transient medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for load balancing for a distributed key-value store.

### Embodiment 1

### Distributed Load Balancing

FIG. 1 is an exemplary diagram of an overall system in which the key-value store of the present invention may be implemented according to the first embodiment. The system includes one or more Nodes 1, one or more Clients 2, and a Network 3. Each Node 1 is connected to the Network 3 via a Communication Line 4. Each Client 2 also is connected to the Network 3 via a Communication Line 4. Nodes 1 are storage nodes where the Key-Value data are stored. The Clients 2 are devices (such as PCs or personal computers) which access the Key-Value data stored in the Nodes 1.

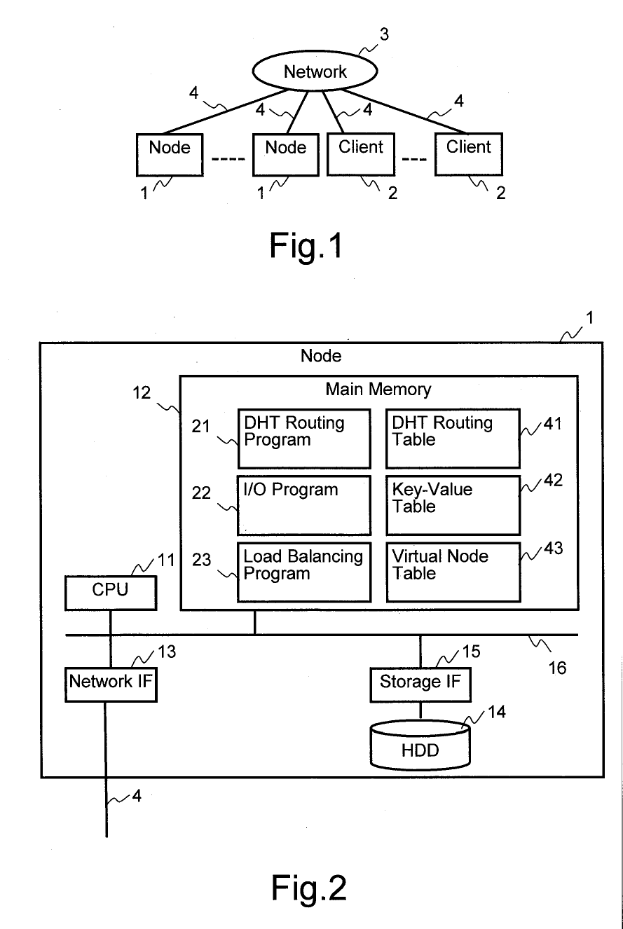

FIG. 2 is a block diagram illustrating components within a Node 1 according the first embodiment of the invention. A Node 1 may include, but is not limited to, CPU (Central Processing Unit) 11, Main Memory 12, Network IF (interface) 13, a storage media such as HDD (Hard Disk Drives) 14, Storage IF 15, and System Bus 16. The Main Memory 12 further includes DHT (Distributed Hash Table) Routing Program 21, I/O Program 22, and Load Balancing Program 23, which are computer programs stored in the HDD 14, copied from the HDD 14 to the Main Memory 12 and executed by the CPU 11. The various programs in this disclosure may instead be modules implemented in software, firmware, hardware, or the like. The Main Memory 12 further includes DHT Routing Table 41, Key-Value Table 42, and Virtual Node Table 43, which are stored in the HDD 14, copied from the HDD 14 to the Main Memory 12, read and/or written by the programs and copied back from the Main Memory 12 to the HDD 14. The Storage IF 15 provides raw data storage to the programs. The Network IF 13 connects the Node 1 to the Network 3 via the Communication Line 4 and is used for communication with other Nodes 1 and Clients 2. The CPU 11 represents a central processing unit that executes the computer programs. Commands and data communicated between the CPU and other components are transferred via the System Bus 16.

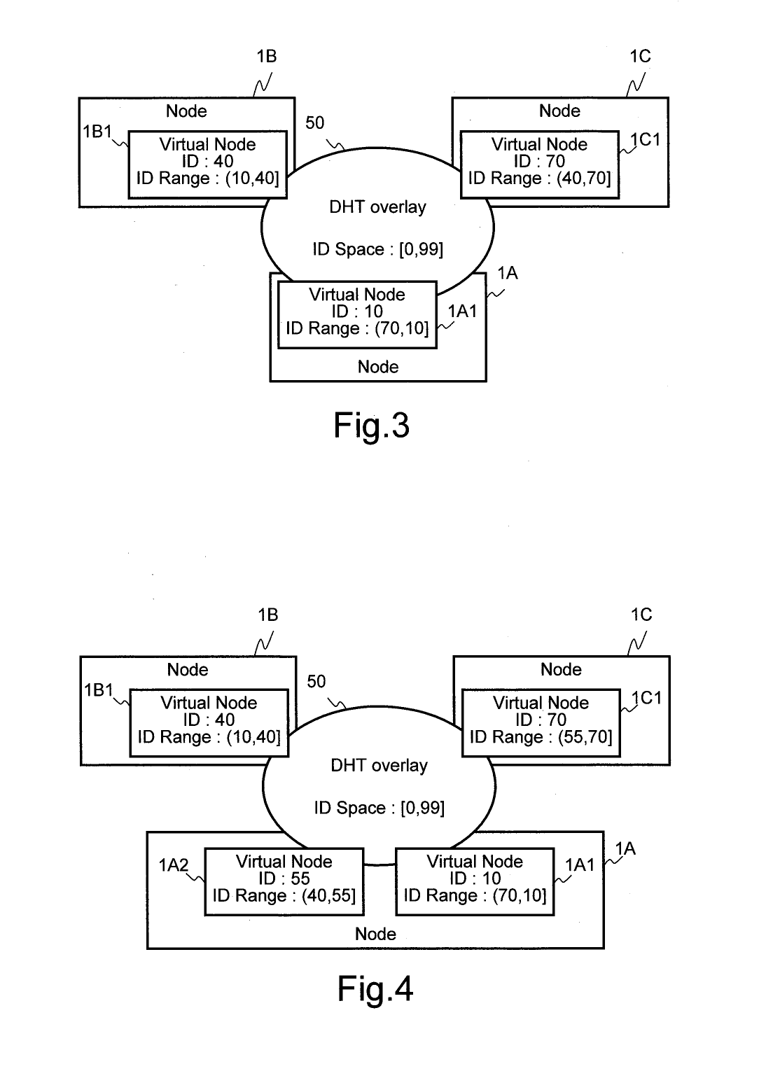

FIG. 3 shows a high level overview of a logical architecture of the system according to the first embodiment. There exist one or more virtual nodes in each Node 1 and the virtual nodes are organized into a DHT overlay. In this embodiment, virtual nodes are used to rebalance resource utilization of a plurality of Nodes 1. If resource utilization of one Node 1 is higher than resource utilization of other Nodes 1, a virtual node is created in another Node 1 with lower resource utilization and Key-Value data stored in the overloaded Node 1 are migrated to the Node 1 with lower resource utilization. In FIG. 3, there are three Nodes 1 (Nodes 1A, 1B, and 1C) and there exists one virtual node in each Node 1 (Virtual Nodes 1A1, 1B1, and 1C1 respectively). Those virtual nodes are organized into the DHT Overlay 50. The DHT overlay 50 manages an ID space, organized into a logical ring where the smallest ID succeeds the largest ID. Key-Value data and virtual nodes are hashed to the same ID space. A hash value is assigned to a responsible virtual node whose ID (called virtual node ID) is numerically closest clockwise in the ID space to the hash value.

A first virtual node in a Node 1 obtains its virtual node ID by executing the DHT Routing Program 21 to calculate a hash value of its IP address. With a collision-free hash function, such as 160-bit SHA-1 or the like, the virtual node ID assigned to the virtual node will be unique in the DHT overlay 50.

Each virtual node in DHT overlay is responsible for a range of ID space that has no overlap with the ID ranges managed by other virtual nodes in the same DHT overlay. FIG. 3 also shows the ID range managed by each virtual node in the DHT Overlay 50 with ID space [0,99]. It should be noted that the ID space form a circle, and therefore ID range managed by Virtual Node 1C1 with virtual node ID 70 is (40˜70], ID range managed by Virtual Node 1A1 with virtual node ID 10 is (70˜10], and ID range managed by Virtual Node 1B1 with virtual node ID 40 is (10˜40], and so on.

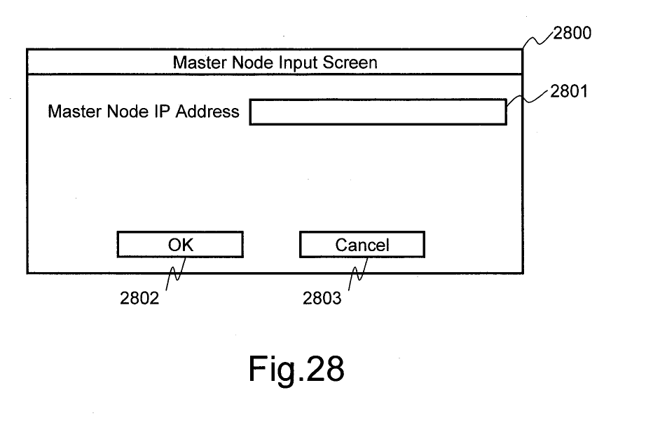

An administrator needs to select one Node 1 as a master node and boot the master node first. A master node is a contact point for other Nodes 1 to get the latest DHT Routing Table 41. The administrator may choose any Node 1 as a master node. Also the administrator needs to configure an IP address of the master node in all other Nodes 1. FIG. 28 shows an example of Master Node Input Screen 2800, containing a text box 2801 which enables an administrator to specify an IP address of a master node, a button 2802 to apply a specified IP address, and a button 2803 to cancel an input of the IP address.

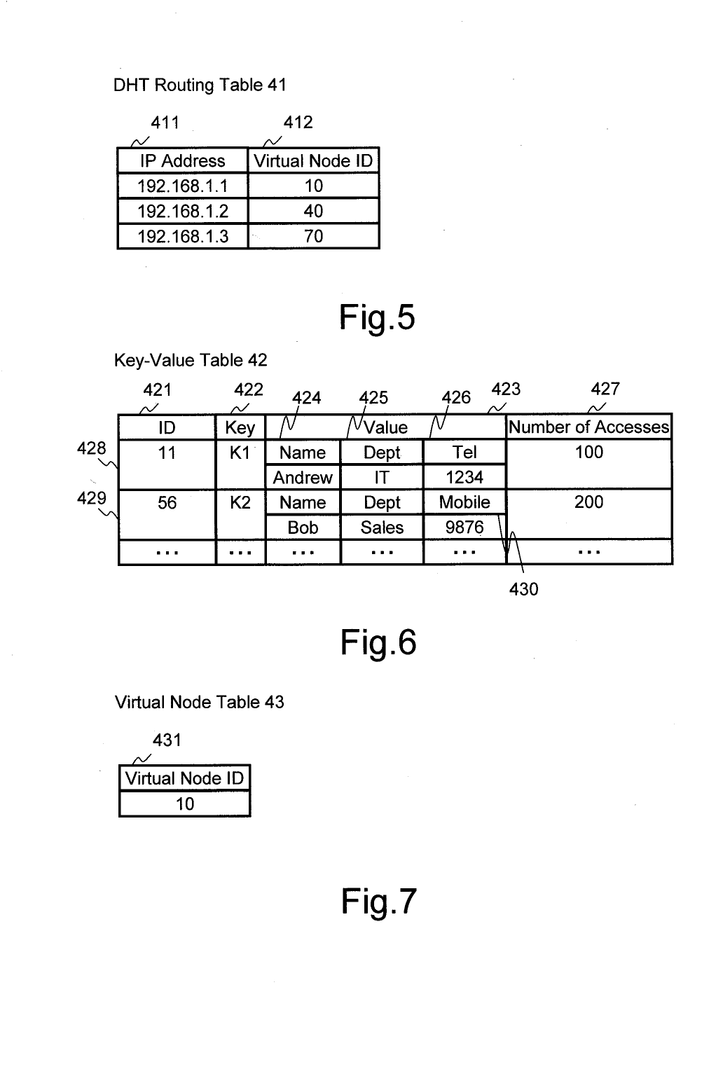

Each Node 1 maintains the DHT Routing Table 41, which stores information of virtual nodes in Nodes 1 known by the current Node 1. Each Node 1 executes the DHT Routing Program 21, which uses and updates the information in DHT Routing Table 41, to corporately form the DHT overlay. FIG. 5 shows an example of a DHT Routing Table 41 maintained in a Node 1. The DHT Routing Table 41 may have, but is not limited to, two columns, including IP address 411 and Virtual Node ID 412. It should be noted that a Node 1 maintains at least three virtual nodes (its predecessor, its successor, and itself) in the same DHT overlay to which it belongs. The predecessor of a virtual node in DHT overlay is a virtual node whose virtual node ID is numerically closest counterclockwise in the ID space. The successor of a virtual node in DHT overlay is a virtual node whose virtual node ID is numerically closest clockwise in the ID space. In this example, for Virtual Node 1A1 with virtual node ID 10 in DHT Overlay 50, its predecessor is Virtual Node 1C1 with virtual node ID 70, and its successor is Virtual Node 1B1 with virtual node ID 40.

Key-Value pairs created by Clients 2 are organized in logical table structure with rows and columns, where each row represents a key-value pair. FIG. 6 shows an example of a user created Key-Value Table 42, which has four columns, including ID 421, Key 422, Value 423, and Number of Accesses 427. A hash value of Key 422 is stored in ID 421 and all rows are sorted based on ID 421 in ascending order. Each row has different sub-columns within Value 423. For example, a row 428 whose Key 422 is K1 has three columns including Name 424, Dept (department) 425, and Tel (telephone number) 426. Meanwhile, a row 429 whose Key 422 is K2 has three columns including Name 424, Dept 425, and Mobile (mobile telephone number) 430.

FIG. 7 shows an example of a Virtual Node Table 43. The Virtual Node Table 43 may have, but is not limited to, one column, including Virtual Node ID 431. The Virtual Node Table 43 maintains virtual node IDs of all virtual nodes which exist in a Node 1.

Process to Organize DHT Overlay

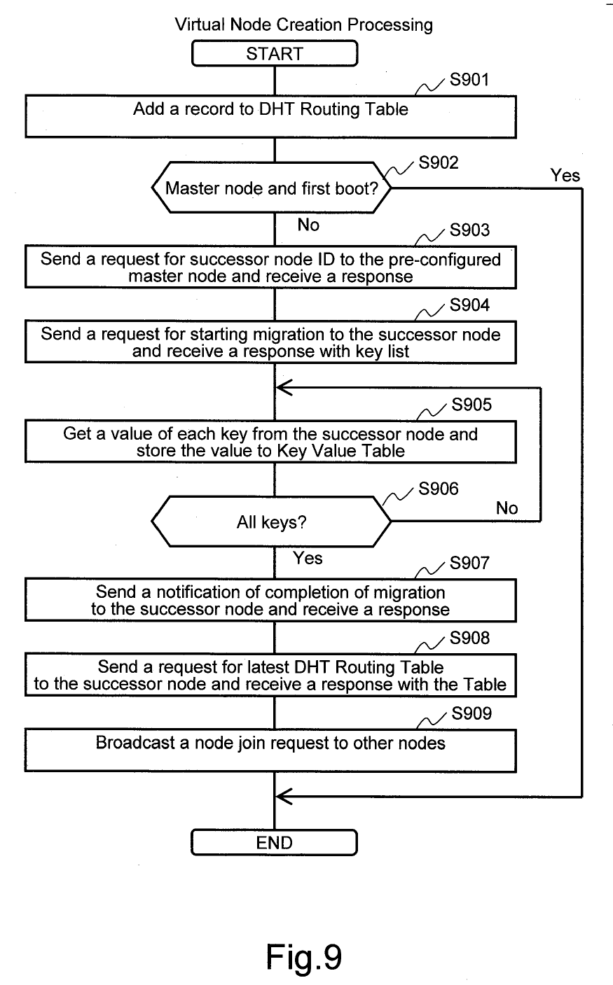

FIG. 9 is an example of a flow diagram illustrating the exemplary steps of Virtual Node Creation Processing. When a Node 1 is booted first, the Node 1 executes this processing according to the DHT Routing Program 21. In this processing, first, the Node 1 adds a new record to the DHT Routing Table 41 to create a new virtual node in the Node 1 (S901). When the Node 1 is booted first, the IP Address 411 of the record is an IP address assigned to the Node 1 and the Virtual Node ID 412 of the record is a hash value of the IP address. The hash value is a virtual node ID of the new virtual node. If the Node 1 is the master node and this is the first boot time, the Node 1 terminates the Virtual Node Creation Processing (S902). Otherwise, the Node 1 sends a request for a virtual node ID of a successor of the new virtual node, to the pre-configured master node. The request includes the virtual node ID of the new virtual node. The master node reads the DHT Routing Table 41, determines a successor based on the virtual node ID of the new virtual node, and sends a response with an IP address and a virtual node ID of the successor to the Node 1. Then, the Node 1 receives the response from the master node (S903). Next, the Node 1 sends a request for starting migration to the IP address of the successor. The request includes the virtual node ID of the new virtual node. Another Node 1 with the successor receives the request, reads the Key-Value Table 42, and creates a list of keys whose IDs are in the range from the virtual node ID of the new virtual node and the virtual node ID of the successor. The Node 1 with the successor sends a response with the key list to the Node 1 with new virtual node (S904). Then, the Node 1 with the new virtual node starts Key-Value data migration. The Node 1 with the new virtual node gets values of all keys in the key list from the Node 1 with the successor and stores the Key-Value pair to the Key-Value Table 42 (S905 and S906). In the Key-Value Table 42 (see FIG. 6), the ID 421 is a hash value of a key and the Number of Accesses 427 is zero for each Key-Value pair. After that, the Node 1 with the new virtual node sends a notification of completion of migration to the Node 1 with the successor. The Node 1 with the successor deletes records of migrated Key-Value pairs from the Key-Value Table 42 and sends a response to the Node 1 with the new virtual node (S907). Next, the Node 1 with the new virtual node sends a request for the latest DHT Routing Table 41 to the Node 1 with the successor. Node 1 with the successor sends a response with the DHT Routing Table 41 which is managed by it. The Node 1 with the new virtual node receives the response and merges the DHT Routing Table 41 included in the response into the existing DHT Routing Table 41 (S908). Lastly, the Node 1 with the new virtual node broadcasts a node join request to all other Nodes 1 in the same DHT overlay. The node join request includes the IP address assigned to Node 1 and the virtual node ID of the new virtual node. Each Node 1 receives the node join request and adds a record to the DHT Routing Table 41 (S909).

Key-Value pairs are distributed to Nodes 1 and stored in the Key-Value Table 42 (see FIG. 6). More specifically, in the DHT Overlay 50, Key-Value pairs are distributed to Nodes 1 based on hash values of keys of the Key-Value pairs. In this embodiment, a Node 1 supports two types of operations to Key-Value pairs, PUT and GET. Client 2 uses PUT operation in order to store a Key-Value pair and uses GET operation in order to read a value corresponding to a key designated by Client 2.

Process to Access Key-Value Pairs

When Client 2 needs to access a Key-Value pair, Client 2 sends a request for the latest DHT Routing Table 41 to any of the Nodes 1 first and determines which virtual node is responsible for a key of the Key-Value pair. Then, Client 2 sends a GET or PUT operation request to an IP address of the determined virtual node.

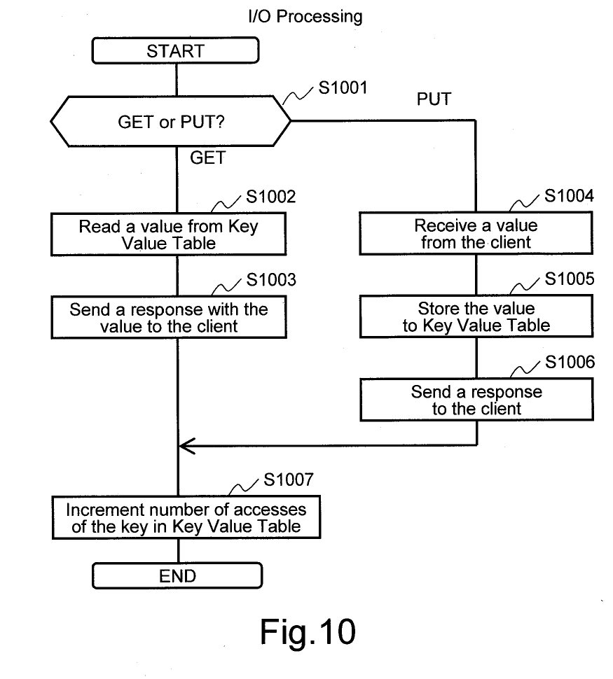

FIG. 10 is an example of a flow diagram illustrating the exemplary steps of I/O Processing. When a Node 1 receives a request from Client 2, the Node 1 executes this processing according to the I/O Program 22. If a type of the requested operation is GET (S1001), the Node 1 reads a value corresponding to a key designated by Client 2, from the Key-Value Table 42 (S1002) and sends a response with the value to Client 2 (S1003). If a type of the requested operation is PUT (S1001), the Node 1 receives a key and a value from Client 2 (S1004), stores the key and value to the Key-Value Table 42 (S1005), and sends a response to Client 2 (S1006). Lastly, the Node 1 increments the Number of Accesses 427 of the record corresponding to the accessed Key-Value pair (S1007).

Process to Perform Load Balancing

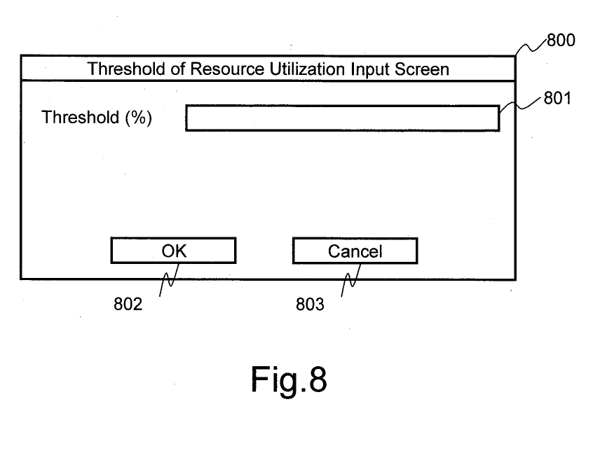

An administrator may configure a threshold for resource (CPU, HDD and so on) utilization of a Node 1 by using a Threshold of Resource Utilization Input Screen 800 so that the Node 1 starts load balancing processing if resource utilization of the Node 1 exceeds the threshold. FIG. 8 shows an example of a Threshold of Resource Utilization Input Screen 800, containing a text box 801 which enables an administrator to specify a threshold for resource utilization of a Node 1, a button 802 to apply a specified threshold, and a button 803 to cancel an input of the threshold. In a specific embodiment, each Node 1 has the same threshold for resource utilization.

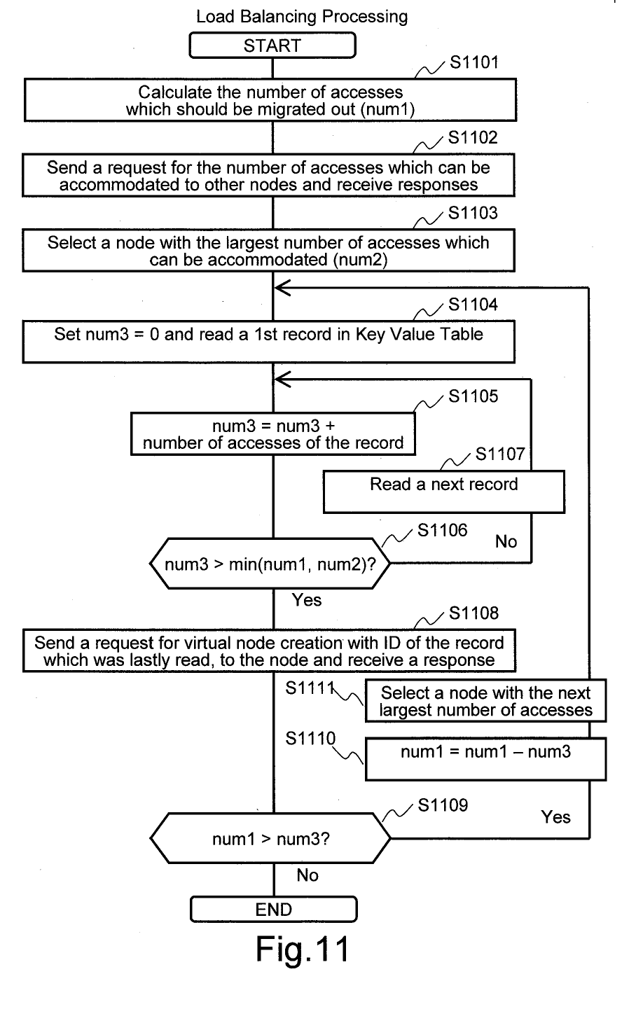

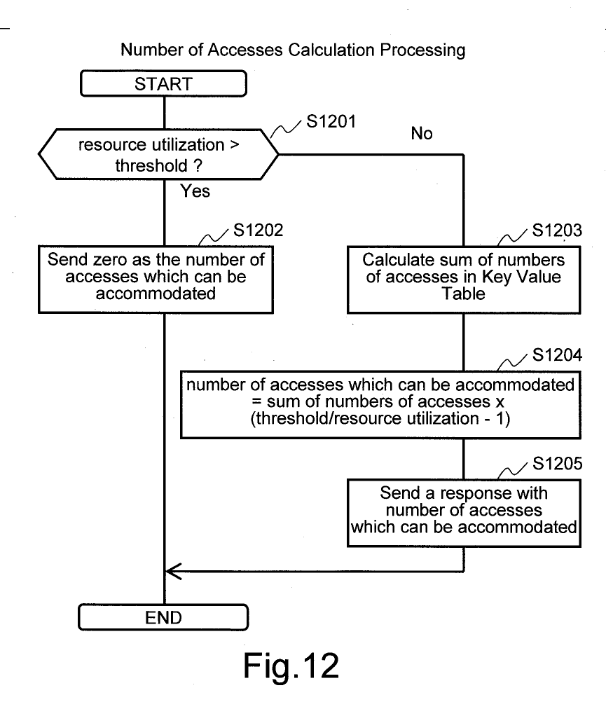

FIG. 11 is an example of a flow diagram illustrating the exemplary steps of Load Balancing Processing. A Node 1 periodically checks whether resource utilization exceeds the threshold configured by the administrator. If resource utilization does not exceed the threshold, the Node 1 updates the Number of Accesses 427 of all records in the Key-Value Table 42 to zero. If resource utilization exceeds the threshold, the Node 1 should be regarded as an overloaded node and executes this processing according to the Load Balancing Program 23. First, the overloaded node reads the Number of Accesses 427 of all records of the Key-Value Table 42, calculates a sum of the Number of Accesses 427, and calculates the number of accesses which should be migrated out so that resource utilization becomes below the threshold and sets the number as num1 (S1101). For example, num1 may be calculated by the following equation, num1=sum of Number of Accesses×(1−threshold/resource utilization). Next, the overloaded node reads the DHT Routing Table 41 to get a list of IP addresses of Nodes 1 and sends requests for the number of accesses which can be accommodated to other Nodes 1. The overloaded node may choose one or any number of Nodes 1 randomly. Alternatively, the overloaded node may send the requests to all other Nodes 1. Each Node 1 receives the request, calculates the number of accesses which can be accommodated, and sends a response to the overloaded node (S1102). Calculation of the number of accesses which can be accommodated is described later by referring to FIG. 12. Next, the overloaded node selects a Node 1 (referred as the target node) with the largest number of accesses which can be accommodated and sets the largest number as num2 (S1103). Next, the overloaded node sets zero to num3 and reads a first record of the Key-Value Table 42 (S1104). The overloaded node adds the Number of Accesses 427 of the record to num3 (S1105). If num3 is smaller than num1 and num2 (S1106), the overloaded node reads a next record from the Key-Value Table 42 (S1107) and repeats S1105. Otherwise, the overloaded node sends a request for creation of a new virtual node to the target node. An ID of the new virtual node is ID 421 of the record which was read last. Then, the target node executes the Virtual Node Creation Processing (FIG. 9) and sends a response to the overloaded node (S1108). If num1 is greater than num3 (S1109), resource utilization may be still higher than the threshold. Therefore, the overloaded node removes num3 from num1 (S1110), selects a Node 1 with the next largest number of accesses which can be accommodated, as the target node (S1111) and repeats S1104 to S1109. Lastly, the overloaded Node 1 updates the Number of Accesses 427 of all records in the Key-Value Table 42 to zero.

In FIG. 11, the migration range is determined by accumulating the number of accesses from the top record of the Key-Value Table 42 (reading a first record in S1104 and reading a next record in S1107). However, the minimum requirement for the process is merely to select consecutive key range as the migration range, since the system is managed by hash value. Therefore, for example, it is possible to specify a key with the biggest number and decide a key range including that specified key. The range does not necessarily begin and end at the end of the range managed by the node. For example, Node 1B in FIG. 3 manages range [10, 40] but the migration range need not start with 10 and need not to be end with 40. Therefore the migration range might be [10, 30] or [20, 40]. Also, it can start at an intermediate number and end at another intermediate number. For example, a migration range might be (20, 30).

FIG. 12 is an example of a flow diagram illustrating the exemplary steps of Number of Accesses Calculation Processing. When a Node 1 receives a request for the number of accesses which can be accommodated by it from an overloaded node, the Node 1 executes this processing according to the Load Balancing Program 23. If resource utilization of the Node 1 is also over the threshold (S1201), the Node 1 sends a response to the overloaded node, which includes zero as the number of accesses which can be accommodated (S1202). Otherwise, the Node 1 reads the Number of Accesses 427 of all records of the Key-Value Table 42 and calculates a sum of the Number of Accesses 427 (S1203). Then, the Node 1 calculates the number of accesses which can be accommodated (S1204). For example, the number of accesses which can be accommodated may be calculated based on the following equation, the number of accesses which can be accommodated=sum of Number of Accesses×(threshold/resource utilization−1). Lastly, the Node 1 sends a response which includes the calculated number of accesses which can be accommodated to the overloaded node (S1205).

As mentioned above, load can be rebalanced across a plurality of Nodes 1 based on the number of accesses even if only some of the Key-Value pairs are frequently accessed. For example, in FIG. 4, if resource utilization of Node 1C exceeds the threshold, then Node 1C executes the Load Balancing Processing and finds that Node 1A has the largest number of accesses which can be accommodated. In other words, Node 1A has the lowest resource utilization. In that case, Node 1C sends a request to Node 1A and Node 1A creates a new Virtual Node 1A2 with the ID range from (40, 55] and migrates Key-Value pairs with IDs which ranges from 40 to 55. As a result, accesses to Key-Value pairs are rebalanced across a plurality of Nodes 1 and total performance of the system is improved.

### Embodiment 2

### Centralized Load Balancing

A second embodiment of the present invention will be described next. The explanation will mainly focus on the differences from the first embodiment. In this embodiment, one Node 1 in the same DHT overlay is selected as a responsible node. A responsible node is responsible for control of load balancing in the DHT overlay. For example, a Node 1 in which a virtual node with the smallest virtual node ID exists may become a responsible node, but the way to select the responsible node is not limited to this. In FIG. 3, Node 1A with Virtual Node 1A1 with the smallest virtual node ID 10 is a responsible node.

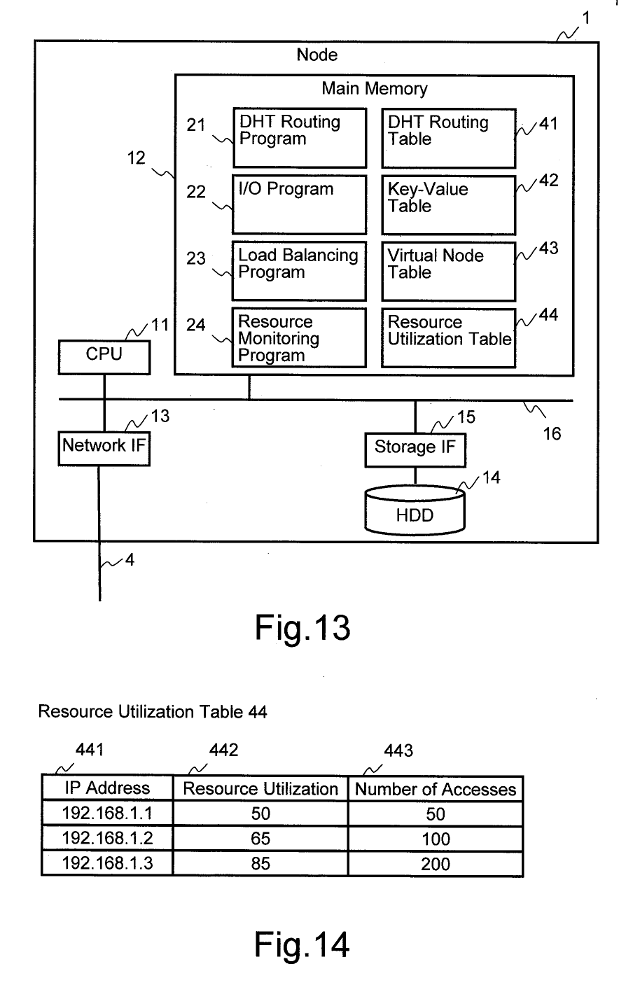

FIG. 13 is a block diagram illustrating the components within a Node 1 according to the second embodiment. The Main Memory 12 includes Resource Monitoring Program 24 and Resource Utilization Table 44 in addition to the programs and the tables described in the first embodiment (see FIG. 2).

FIG. 14 shows an example of a Resource Utilization Table 44. The Resource Utilization Table 44 may have, but is not limited to, three columns, including IP Address 441, Resource Utilization 442, and Number of Accesses 443.

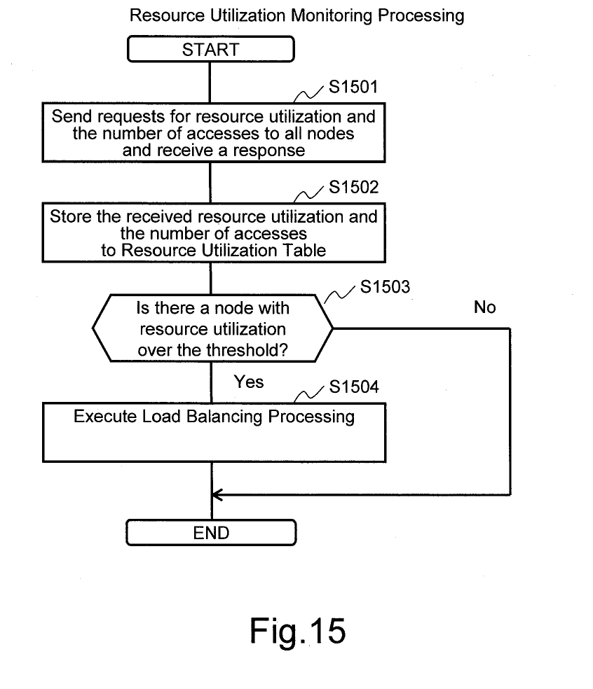

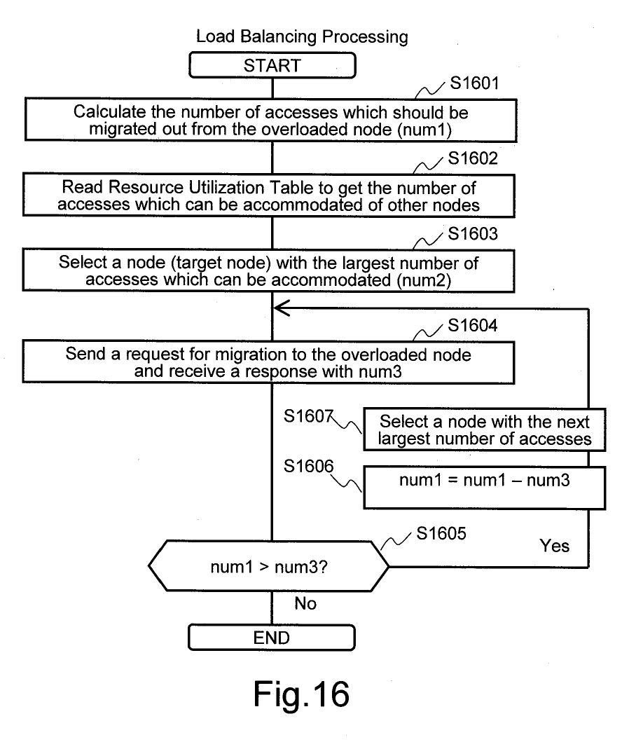

FIG. 15 is an example of a flow diagram illustrating the exemplary steps of Resource Utilization Monitoring Processing. If a Node 1 reads the DHT Routing Table 41 and decides it should be a responsible node, the Node 1 starts to execute Resource Utilization Monitoring Processing periodically according to the Resource Monitoring Program 24. First, a responsible node sends requests for resource utilization and the number of accesses to all Nodes 1 in the same DHT overlay including it. Then, each Node 1 reads the Key-Value Table 42 to calculate a sum of the Number of Accesses 427 and sends a response with resource utilization and the calculated sum of Number of Accesses 427 to the responsible node (S1501). After that, the Node 1 updates the Number of Accesses 427 of all records in the Key-Value Table 42 to zero. Next, the responsible node updates records in the Resource Utilization Table 44 with the resource utilization and the sum of the Number of Accesses 427 which are included in the response (S1502). Next, the responsible node checks if there is a Node 1 with resource utilization over the threshold (S1503). If there is such a Node1 (referred to as an overloaded node), the responsible node executes Load Balancing Processing in this embodiment (S1504), which is described later by referring to FIG. 16. Otherwise, the responsible node terminates the Resource Utilization Monitoring Processing.

FIG. 16 is an example of a flow diagram illustrating the exemplary steps of Load Balancing Processing according to the second embodiment, which is executed by a responsible node according to the Load Balancing Program 23. First, the responsible node reads the Resource Utilization Table 44 to calculate the number of accesses which should be migrated out from the overloaded node and sets the number as num1 (S1601). For example, num1 may be calculated by the following equation, num1=sum of Number of Accesses of the overloaded node×(1−threshold/resource utilization of the overloaded node). Next, the responsible node reads the Resource Utilization Table 44 to calculate the number of accesses which can be accommodated by Nodes 1 other than the overloaded node (S1602). Then the responsible node selects a Node 1 (referred to as a target node) with the largest number of accesses which can be accommodated and sets the number as num2 (S1603). Next the responsible node sends a request for Key-Value pairs migration to the overloaded node. The request includes an IP address of the target node, num1, and num2. The responsible node receives a response which includes num3 from the overloaded node (S1604). If num1 is greater than num3 (S1605), resource utilization of the overloaded node may be still higher than the threshold. Therefore, the responsible node removes num3 from num1 (S1606), selects a Node 1 with the next largest number of accesses which can be accommodated, as the target node (S1607), and repeats S1604 to S1607.

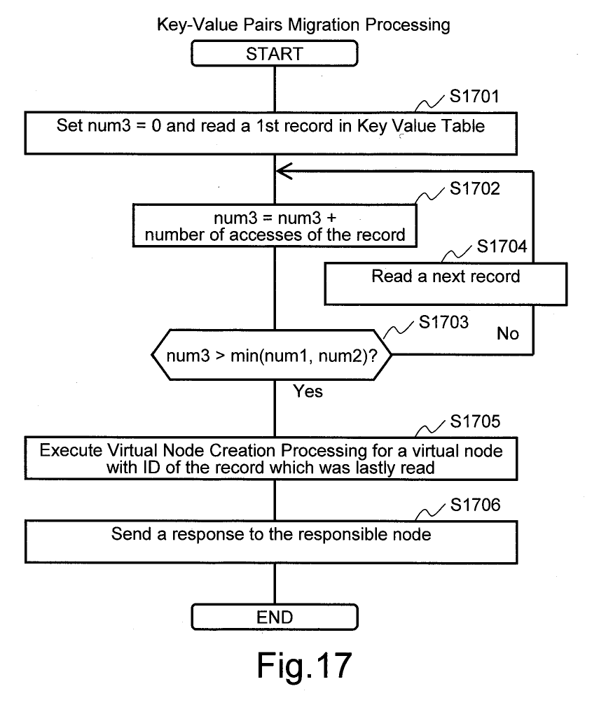

FIG. 17 is an example of a flow diagram illustrating the exemplary steps of Key-Value Pairs Migration Processing. When an overloaded Node 1 (referred to as an overloaded node) receives a request for Key-Value pairs migration, the overloaded node executes Key-Value Pairs Migration Processing according to the Load Balancing Program 23. First, the overloaded node sets num3 to zero and reads a first record in the Key-Value Table 42 (S1701). Next, the overloaded node adds the Number of Accesses 427 of the record to num3 (S1702). If num3 is smaller than num1 and num2 (S1703), the overloaded node reads a next record from the Key-Value Table 42 (S1704) and repeats S1702 to S1703. Otherwise, the overloaded node sends a request for creation of a new virtual node to the target node. An ID of the new virtual node is ID 421 of the record which was read last. Then, the target node executes Virtual Node Creation Processing and sends a response to the overloaded node (S1705). Lastly, the overloaded node sends a response with num3 to the responsible node (S1706).

Thus, according to the second embodiment, a responsible node can control load balancing tasks in a centralized manger to avoid conflict across a plurality of load balancing tasks. Such conflict may occur in the first embodiment in which each Node 1 executes the Load Balancing Processing in a distributed manner. For example, FIG. 4 shows another high level overview of a logical architecture of the system to illustrate conflict across a plurality of load balancing tasks. In FIG. 4, during Key-Value pairs migration from Node 1C to Node 1A, Node 1B also may be overloaded, executes the Load Balancing Processing, and requests Node 1C to create a new virtual node. As a result, resource utilization of Node 1C may exceed the threshold. The second embodiment avoids this problem by providing a load balancing method in a centralized manner.

### Embodiment 3

### Hierarchical Load Balancing

A third embodiment of the present invention will be described next. The explanation will mainly focus on the differences from the first and the second embodiments. The third embodiment has an advantage over the second embodiment if there are a large number of Nodes 1 in the DHT overlay, such that the load of a responsible node becomes heavy. In addition, if the Nodes 1 in different locations (e.g., multiple data centers) organizes one DHT overlay, the network traffic generated by the Resource Utilization Processing and Key-Value Pairs Migration Processing may consume bandwidth across locations and cause congestion. The third embodiment avoids this problem by providing a load balancing method in a hierarchical manner.

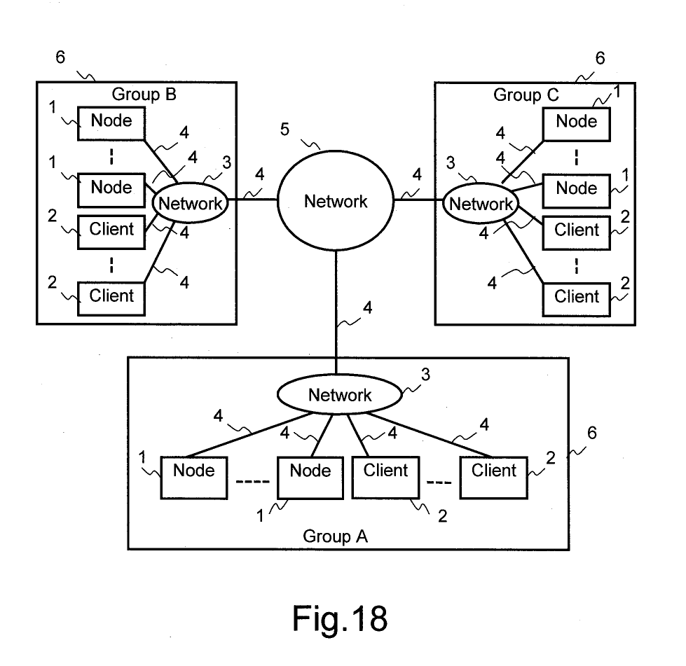

FIG. 18 is an exemplary diagram of an overall system according to the third embodiment of the invention. The system includes one or more Groups 6. A Group 6 represents a group of devices which are located at a short distance with respect to each other. Each Group has one or more Nodes 1, one or more Clients 2, and a Network 3. Each Node 1 is connected to the Network 3 via a communication line 4. Each Client 2 also is connected to the Network 3 via a communication line 4. The Network 3 is further connected to another Network 5 outside the Group via a communication line 4.

For example, a Group 6 might be a group of devices which are located at the same rack. In that case, the Network (internal) 3 and Network (external) 5 each would be a LAN (Local Area Network). Alternatively, a Group 6 might be a group of devices which are located at the same data center. In that case, the Network 3 would be LAN and the Network 5 would be WAN (Wide Area Network).

An administrator needs to configure a DHT Overlay ID to each Node 1 to designate to which DHT overlay each Node 1 should belong. In addition, the administrator needs to select one Node 1 in each Group 6 as a master node for the group and boot the master node first in the Group 6. The administrator may choose any Node 1 as a master node. Also the administrator needs to select one master node in the system as a group master node and boot the group master node first in the system. A group master node is a contact point for responsible nodes to get the latest Group DHT Routing Table 45. The administrator may choose any master node as a group master node.

FIG. 24 shows an example of a DHT Overlay ID Input Screen 2400, containing a text box 2401 which enables the administrator to specify a DHT overlay ID, a text box 2402 which enables the administrator to specify an IP address of a master node in the group, a text box 2403 which enables the administrator to specify an IP address of a group master node in the system, a button 2404 to apply a specified values, and a button 2405 to cancel an input of the values. If a Node 1 is a master node, there is no need to specify an IP address of a master node in the text box 2402. If a Node 1 is a group master node, there is no need to specify an IP address of a master node in the text box 2402 and an IP address of a group master node in the text box 2403.

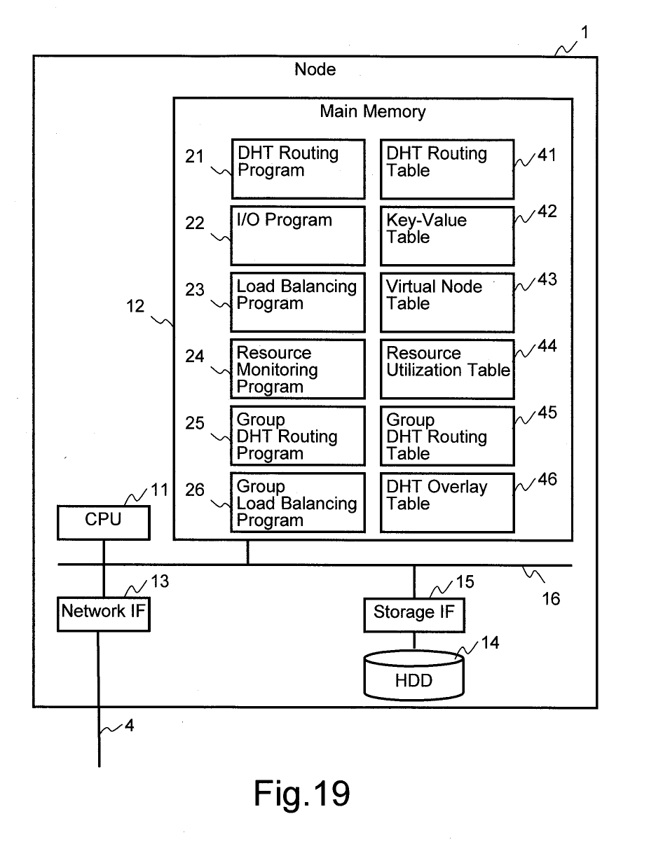

FIG. 19 is a block diagram illustrating components within a Node 1 according to the third embodiment. The Main Memory 12 includes Group DHT Routing Program 25 and Group Load Balancing Program 26 in addition to the programs described in the second embodiment (see FIG. 13). The Main Memory 12 further includes Group DHT Table 45 and DHT Overlay Table 46 in addition to the tables described in the second embodiment.

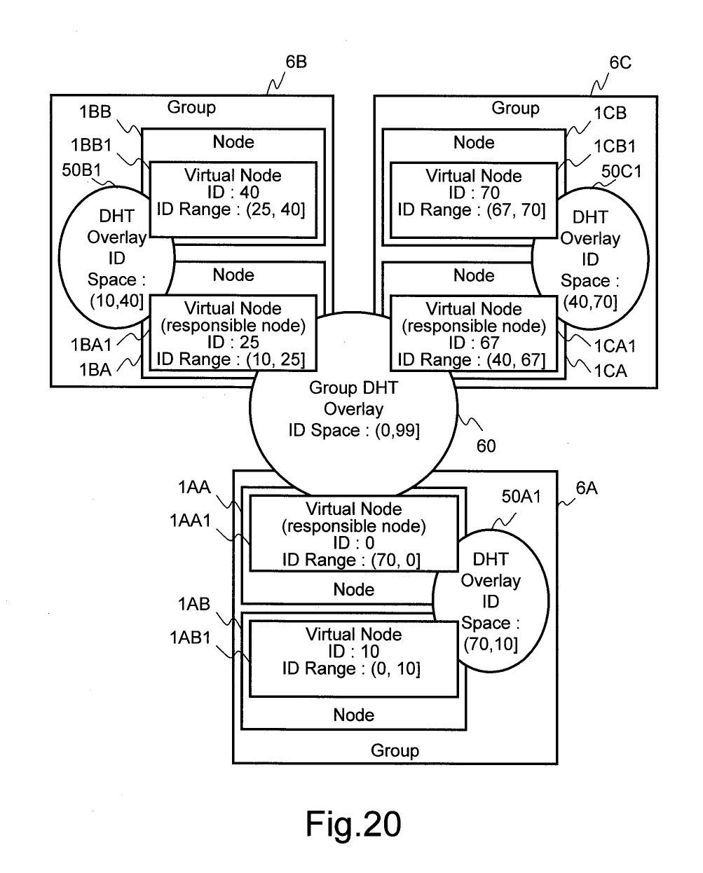

FIG. 20 shows a high level overview of a logical architecture of the system according to the third embodiment. There exist one or more Groups 6 in the system. In each Group 6, there exist one or more Nodes 1. In each Node 1, there exist one or more virtual nodes and the virtual nodes are organized into a DHT overlay. One Node 1 in the same DHT overlay is selected as a responsible node. For example, a Node 1 in which a virtual node with the smallest virtual node ID exists may become a responsible node. Responsible nodes are organized into another DHT overlay across Groups 6. This DHT overlay is referred as a group DHT overlay 60 in this embodiment. In FIG. 20, there are three Groups 6 in the system, Groups 6A, 6B, and 6C. In Group 6A, there are two Nodes 1, Node 1AA and Node 1AB. In each Node 1, there is one virtual node, Virtual Node 1AA1 with ID 0 and Virtual Node 1AB1 with ID 10 respectively. The Virtual Nodes 1AA1 and 1AB1 are organized into a DHT Overlay 50A1 with ID Space from 70 to 10. In Group 6A, the Virtual Node 1AA1 is a responsible node. Similarly, there are Nodes 1BA and 1BB in Group 6B. In each Node 1, there are Virtual Node 1BA1 with ID 25 and Virtual Node 1BB1 with ID 40, which are organized into a DHT Overlay 50B1 with ID Space from 10 to 40. In Group 6B, the Virtual Node 1BA1 is a responsible node. There are Nodes 1CA and 1CB in Group 6C. In each Node 1, there are Virtual Node 1CA1 with ID 67 and Virtual Node 1CB1 with ID 70, which are organized into a DHT Overlay 50C1 with ID Space from 40 to 70. In Group 6C, the Virtual Node 1CA1 is a responsible node. The responsible nodes, Virtual Nodes 1AA1, 1BA1 and 1CA1, are organized into a Group DHT Overlay 60 with ID Space from 0 to 99.

A virtual node in a Node 1 obtains its virtual node ID by executing the DHT Routing Program 21 to concatenate a hash value of a DHT overlay ID and a hash value of an IP address. For example, a virtual node ID may have 320-bits. High 160-bits and low 160-bits are a hash value of a DHT overlay ID calculated by SHA-1 of and a hash value of IP address calculated by SHA-1 respectively. In this way, all virtual nodes in all groups are organized into a single DHT overlay ID space.

Each responsible node maintains the Group DHT Routing Table 45, which stores information of responsible nodes in the system known by the current responsible node. Each responsible node executes the Group DHT Routing Program 25, which uses and updates the information in the Group DHT Routing Table 45, to corporately form the Group DHT overlay 60.

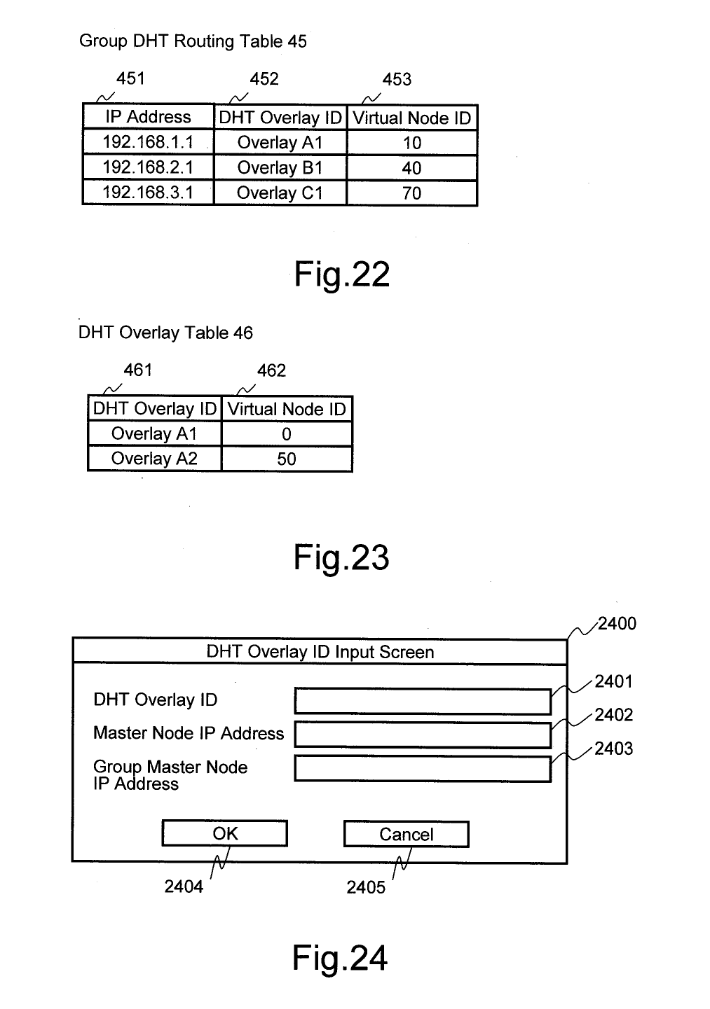

FIG. 22 shows an example of a Group DHT Routing Table 45 maintained in a responsible node. The Group DHT Routing Table 45 may have, but is not limited to, three columns, including IP address 451, DHT Overlay ID 452 and Virtual Node ID 453. It should be noted that a responsible node maintains at least three virtual nodes (its predecessor, its successor, and itself) in the Group DHT overlay 60. The predecessor of a responsible node in the Group DHT overlay is a responsible node whose virtual node ID is numerically closest counterclockwise in the ID space. The successor of a responsible node in DHT overlay is a responsible node whose virtual node ID is numerically closest clockwise in the ID space. In this example, for the Virtual Node 1AA1 (a responsible node in Group 6A) with virtual node ID 0 in the Group DHT Overlay 60, its predecessor is Virtual Node 1CA1 (a responsible node in Group 6C) with virtual node ID 67, and its successor is Virtual Node 1BA1 (a responsible node in Group 6B) with virtual node ID 25.

FIG. 23 shows an example of a DHT Overlay Table 46. The DHT Overlay Table 46 may have, but is not limited to, two columns, including DHT Overlay ID 461 and Virtual Node ID 462. The DHT Overlay Table 46 maintains IDs of all DHT overlays in the Group 6 and virtual node IDs of responsible nodes of the DHT overlays.

Process to Organize DHT Overlay

In each group, a master node is booted first and executes Virtual Node Creation Processing. After that, other nodes in the same group are booted and execute Virtual Node Creation Processing. Detailed steps of Virtual Node Creation Processing are same as the first embodiment except for virtual node ID calculation. In this embodiment, a virtual node ID is calculated based on DHT overlay ID as well as IP address as mentioned. After all nodes are booted in each group, a responsible node is selected. Each responsible node, except a group master node, sends a request for a virtual node ID of a successor to the pre-configured group master node. Next the responsible node sends a request for starting migration to the successor. After a response is received, the responsible node starts Key-Value data migration. After completion of migration, the responsible node sends a request for the latest Group DHT Routing Table 45 to the group master node. Lastly, the responsible node broadcasts a group join request to all other responsible nodes.

Process to Access Key-Value Pairs

When Client 2 needs to access a Key-Value pair, Client 2 sends a request for the latest DHT Routing Table 41 to any of the Nodes 1 in the same group and determines whether the group is responsible for a key of the Key-Value pair. If the group is responsible for the key, Client 2 determines which virtual node in the group is responsible for the key and sends a GET or PUT operation request to the determined virtual node. On the other hand, if the group is not responsible for the key, Client 2 sends a GET or PUT operation request to the responsible node, which has the smallest virtual node ID in the group. Next, the responsible node reads Group DHT Routing Table 45 and determines which group is responsible for the key and an IP address of a responsible node of the other group. The responsible node sends the operation request to the responsible node in the other group. The responsible node in the other group reads DHT Routing Table 41, determines which node is responsible for the key and sends the operation request to the node. Thus, in this embodiment, operation requests are transferred via responsible nodes across two groups.

Process for Load Balancing Across Groups

In each Group 6, a responsible node executes load balancing task within the Group 6, similarly to the second embodiment. If resource utilization of all nodes in the same Group 6 exceeds the threshold configured by the administrator (that is, load balancing is impossible within that Group 6), the responsible node executes Group Load Balancing Processing according to the Group Load Balancing Program 26. Such a Group 6 is referred to as an overloaded group.

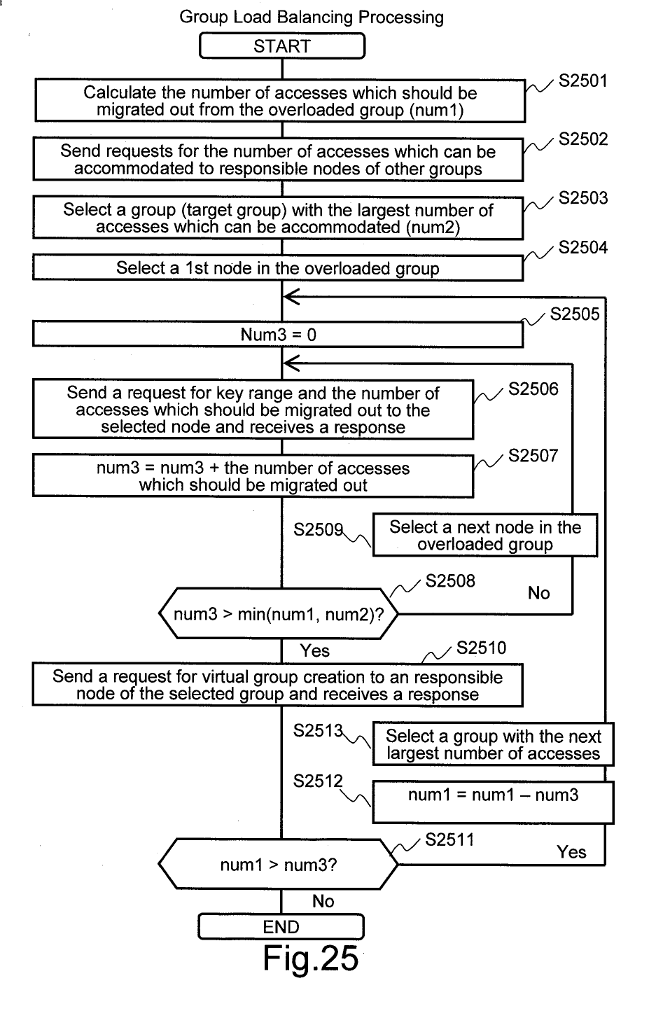

FIG. 25 is an example of a flow diagram illustrating the exemplary steps of Group Load Balancing Processing. First, a responsible node of an overloaded group reads the Resource Utilization Table 44, calculates a sum of the Number of Accesses 443 in the overloaded group, and calculates the number of accesses which should be migrated out from the overloaded group and sets the number as num1 (S2501). For example, num1 may be calculated by the following equation, num1=sum of Number of Accesses of the overloaded group×(1−threshold/average resource utilization of all nodes in the overloaded group). Next, the responsible node sends requests for the number of accesses which can be accommodated to responsible nodes of other groups. A responsible node which receives the request reads the Resource Utilization Table 44, calculates the number of accesses which can be accommodated, and sends a response with the calculated number (S2502). For example, the number of accesses which can be accommodated can be calculated by the following equation, the number of accesses which can be accommodated=sum of Number of Accesses of the group×(threshold/average resource utilization−1). Next, the responsible node selects a group (referred as a target group) with the largest number of accesses which can be accommodated and sets the number as num2 (S2503). Next, the responsible node reads the DHT Routing Table 41 and selects a first node in the overloaded group (S2504) and sets num3 to zero (S2505). Next, the responsible node sends a request for key range and the number of accesses which should be migrated out to the selected target node. The request includes num1 and num2. A Node 1 receives the request, sets num4 to zero, reads the Number of Access 427 of the first record in the Key-Value Table 42, adds the number to num4, and checks whether num4 is smaller than num1 and num2. If num4 is smaller than num1 and num2, the Node 1 reads the Number of Access 427 of the next record in the Key-Value Table 42 and repeats the steps mentioned above. Otherwise, the Node 1 sends a response with num4 as the number of accesses which should be migrated out and key range which starts at the ID 421 of the first record and ends at the ID 421 of the record which is last read (S2506). Next, the responsible node adds the number of accesses which should be migrated out to num3 (S2507) and checks whether num3 is smaller than num1 and num2 (S2508). If num3 is smaller than num1 and num2, the responsible node selects a next node in the overloaded group (S2509) and repeats S2506 to S2508. Then the responsible node sends a request for DHT overlay creation to a responsible node of the selected group. A responsible node receives the request, executes DHT Overlay Creation Processing described later, and sends a response (S2510). If num1 is still greater than num3 (S2511), the responsible node removes num3 from num1 (S2512), selects a group with the next largest number of accesses, selects a next node in the overloaded group (S2513), and repeats S2505 to S2511. Lastly, the responsible node executes Rebalancing Processing described later in order to rebalance load across nodes in the overloaded group.

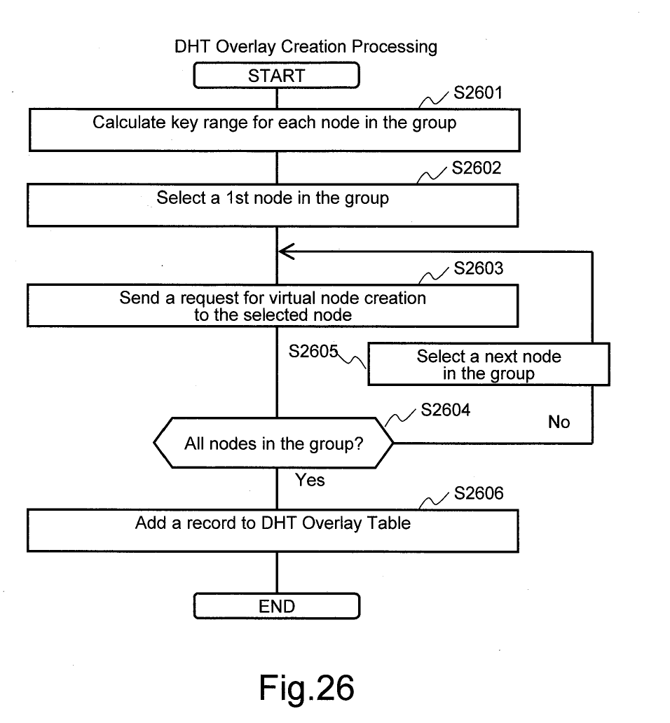

FIG. 26 is an example of a flow diagram illustrating the exemplary steps of DHT Overlay Creation Processing. If a responsible node receives a request for DHT overlay creation from a responsible node of an overloaded group, the responsible node executes DHT Overlay Creation Processing according to the Group DHT Routing Program 45. First, the responsible node calculates key range for each node in the target group (S2601). The key range for each node can be calculated by dividing key range which is included in the request by the number of nodes in the target group. For example, if the key range included in the request is 40 to 60 and the number of nodes is 2, the key ranges for the nodes are 40 to 50 and 50 to 60, respectively. Next, the responsible node reads the DHT Routing Table 41 and selects a first node in the target group (S2602). Next, the responsible node sends a request for creation of virtual node with the calculated key range and DHT overlay ID to the selected node (S2603). The DHT overlay ID can be any string but must be unique. The responsible node repeats S2603 for all nodes in the target group (S2604 and S2605). Lastly, the responsible node adds a record to the DHT Overlay Table 46 (S2606). Thus, newly created virtual nodes are organized into a new DHT overlay and Key-Value pairs are migrated from the nodes in the overloaded group to the nodes in the new DHT overlay.

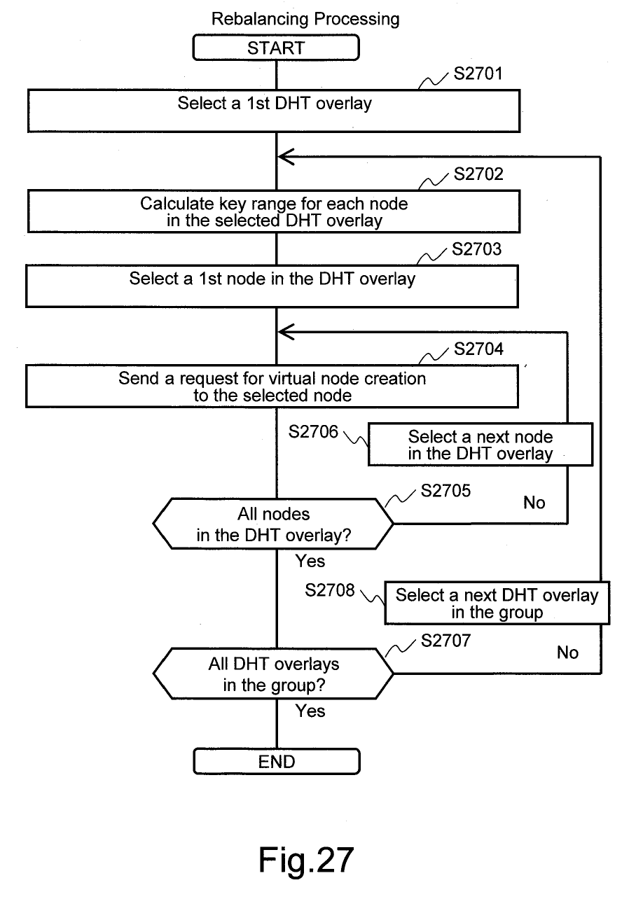

FIG. 27 is an example of a flow diagram illustrating the exemplary steps of Rebalancing Processing. A responsible node in the overloaded group executes Rebalancing Processing according to the Group Load Balancing Program 26. First, the responsible node reads the DHT Overlay Table 46 and selects a first DHT Overlay (S2701). Next, the responsible node calculates key range for each node in the selected DHT overlay (S2702). The key range for each node can be calculated by dividing the key range of the selected DHT overlay by the number of nodes in the overloaded group. For example, if the key range is 60 to 70 and the number of nodes is 2, the key ranges for the nodes are 60 to 65 and 65 to 70, respectively. Next, the responsible node reads the DHT Routing Table 41 and selects a first node in the DHT overlay (S2703). Next, the responsible node sends a request for key range update of virtual node with the calculated key range and DHT overlay ID to the selected node (S2704). The responsible node repeats S2704 for all nodes in the DHT overlay (S2705 and S2706). The responsible node repeats S2702 to S2706 for all DHT overlays in the overloaded group (S2707 and S2708).

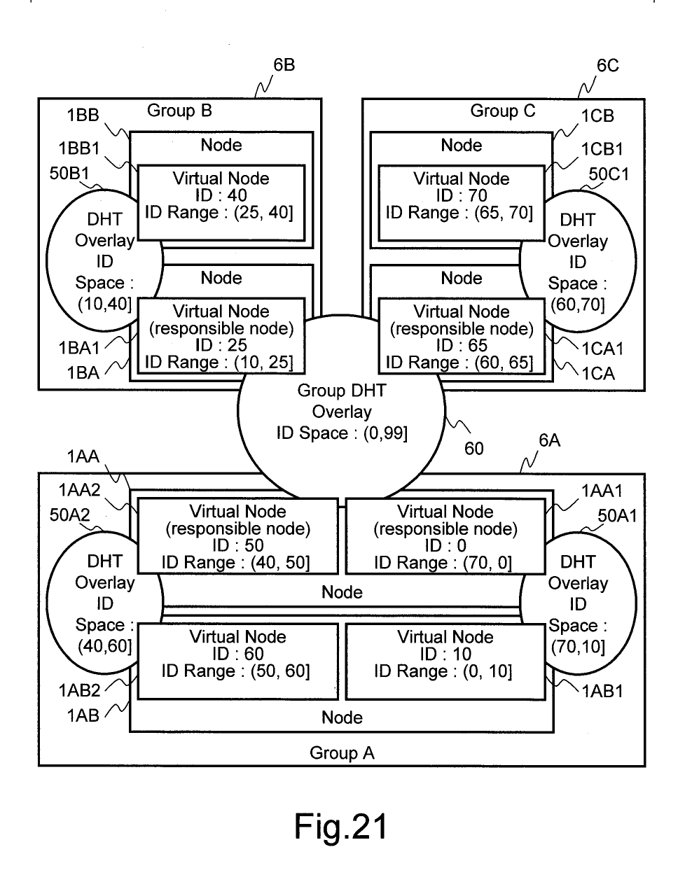

In this embodiment, the load can be rebalanced across a plurality of Groups 6 based on the number of accesses even if Key-Value pairs only in one Group 6 are frequently accessed. For example, FIG. 21 illustrates the creation of a new virtual node in a group in the system of FIG. 20. In FIG. 21, if resource utilization of all nodes in Group 6C with ID range from 40 to 70 exceeds the threshold, then Node 1CA, in which a responsible node 1CA1 in Group 6C exists, executes Load Balancing Processing and finds Group 6A has the largest number of accesses which can be accommodated. In other words, Group 6A has the lowest resource utilization in the system. In that case, Node 1CA sends a request to Node 1AA, in which a responsible node 1AA1 in Group 6A exists, and Node 1AA creates a new Virtual Node 1AA2 and 1AB2 with the same DHT overlay ID (e.g., DHT Overlay A1) and the ID range from 40 to 60 and migrates Key-Value pairs with IDs in the range. As a result, accesses to Key-Value pairs are rebalanced across a plurality of Groups 6 and total performance of the system is improved.

Similar to the second embodiment, a group responsible node may be selected among responsible nodes and the group responsible node controls rebalance tasks across Groups 6 by requesting migration from the overloaded group to the other group in a centralized manner.

Of course, the system configurations illustrated in FIGS. 1 and 18 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for load balancing for a distributed key-value store. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A system comprising:
a plurality of nodes being configured to allow input/output (I/O) access to a plurality of data, each data being accessed as a value via a unique key which is associated with the value as a key-value pair, the plurality of data being distributed and stored among the plurality of nodes based on hush values of the keys each of which is associated with one of the plurality of data as a value;
wherein each node includes an I/O module to record a number of I/O accesses to each key of a plurality of keys associated with the plurality of data as values, respectively, to form the key-value pairs; and
wherein if resource utilization of one of the nodes exceeds a preset threshold, then the node is an overloaded node, and the overloaded node migrates out a part of the key-value pairs in the overloaded node.

2. The system according to claim 1, wherein the overloaded node is configured to:
calculate a number of I/O accesses to be migrated out from the overloaded node; and
determine a key range in the overloaded node to be migrated out based on the calculated number of I/O accesses to be migrated out from the overloaded node in order to reduce the resource utilization to a level below the preset threshold.

3. The system according to claim 2, wherein the overloaded node is configured to:
request a target node to create a virtual node, which is responsible for the key range to be migrated, in the target node; and
migrate key-value pairs in the determined key range to the target node.

4. The system according to claim 1,
wherein each of the plurality of nodes includes a number of accesses calculation module which is configured, in response to a request from the overloaded node, to calculate a number of I/O accesses the node can accommodate from the overloaded node and provide the calculated number of I/O accesses to the overloaded node; and
wherein the overloaded node is configured to select a target node, from the plurality of nodes other than the overloaded node, which can accommodate a largest number of I/O accesses from the overloaded node.

5. The system according to claim 1,
wherein one of the nodes is a responsible node configured to collect resource utilization and a number of accesses of each of the plurality of nodes; and
wherein the responsible node has a load balancing module which requests the overloaded node to execute the migration process to migrate out a part of the key-value pairs in the overloaded node if the resource utilization of a node exceeds the preset threshold.

6. The system according to claim 5,
wherein the load balancing module of the responsible node is configured to calculate a number of I/O accesses to be migrated out from the overloaded node; select a target node, from the plurality of nodes other than the overloaded node, which can accommodate a largest number of I/O accesses from other nodes; and request the overloaded node to execute migration of a part of the key-value pairs to the target node in order to reduce the resource utilization to a level below the preset threshold; and
wherein the overloaded node has a key-value pairs migration module configured, in response to the request from the responsible node to execute migration, to:
determine a key range in the overloaded node to be migrated out based on the calculated number of I/O accesses to be migrated out from the overloaded node in order to reduce the resource utilization to a level below the preset threshold;
request the target node to create a virtual node, which is responsible for the key range to be migrated, in the target node; and
migrate key-value pairs in the determined key range to the target node.

7. The system according to claim 5,
wherein the plurality of nodes are divided into a plurality of groups of multiple nodes;
wherein the responsible node is a node in each group configured to collect resource utilization and a number of accesses of each of the multiple nodes in the group; and
wherein if the resource utilization of all nodes in the group exceeds the preset threshold, then the group is an overloaded group having overloaded nodes, and the responsible node in the overloaded group has a group load balancing module configured to execute a migration process to migrate out a part of the key-value pairs in at least one overloaded node in the overloaded group.

8. The system according to claim 7, wherein the group load balancing module of the responsible node in the overloaded group is configured to:
calculate a number of I/O accesses to be migrated out from the overloaded group;
select a target group, from the plurality of groups other than the overloaded group, which can accommodate a largest number of I/O accesses from the overloaded group;
select the at least one overloaded node in the overloaded group;
determine a key range in each selected node of the selected at least one overloaded node to be migrated out based on the calculated number of I/O accesses to be migrated out from the overloaded group;
request the responsible node of the target group to create a DHT overlay of virtual nodes in target nodes in the target group which are responsible for the key range of each selected node to be migrated; and
request the selected at least one overloaded node to execute migration of a part of the key-value pairs to the target group in order to reduce the resource utilization of the overloaded group to a level below the preset threshold.

9. The system according to claim 8, wherein the responsible node of the target group has a group DHT (Distributed Hash Table) routing module configured, in response to a request from the group load balancing module of the responsible node in the overloaded group to create a DHT overlay, to:
determine a key range in each target node of the target group to receive key-value pairs to be migrated from the overloaded group based on the key range in the selected at least one overloaded node determined by the group load balancing module of the responsible node of the overloaded group; and
request each target node to create a virtual node, which is responsible for at least a portion of the key range of the selected at least one overloaded node to be migrated, in the target node.

10. The system according to claim 7,
wherein the group load balancing module of the responsible node in the overloaded group is configured, after executing the migration process to migrate out a part of the key-value pairs in at least one overloaded node in the overloaded group, to rebalance load among the plurality of nodes in the overloaded group.

11. A load balancing method for a system which includes a plurality of nodes being configured to allow input/output (I/O) access to a plurality of data, each data being accessed as a value via a unique key which is associated with the value as a key-value pair, the plurality of data being distributed and stored among the plurality of nodes based on hush values of the keys each of which is associated with one of the plurality of data as a value, the method comprising:
recording a number of I/O accesses to each key of a plurality of keys associated with the plurality of data as values, respectively, to form key-value pairs; and
if resource utilization of one of the nodes, as an overloaded node, exceeds a preset threshold, then migrating out a part of the key-value pairs in the overloaded node.

12. The method according to claim 11, further comprising:
calculating a number of I/O accesses to be migrated out from the overloaded node; and
determining a key range in the overloaded node to be migrated out based on the calculated number of I/O accesses to be migrated out from the overloaded node.

13. The method according to claim 12, further comprising:
requesting a target node to create a virtual node, which is responsible for the key range to be migrated, in the target node; and
migrating, by the overloaded node, key-value pairs in the determined key range to the target node.

14. The method according to claim 11, further comprising:
in response to a request from the overloaded node, calculating a number of I/O accesses each of the plurality of nodes can accommodate from the overloaded node and providing the calculated number of I/O accesses to the overloaded node; and
selecting, by the overloaded node, a target node, from the plurality of nodes other than the overloaded node, which can accommodate a largest number of I/O accesses from the overloaded node.

15. The method according to claim 11, further comprising:
collecting, by one of the nodes as a responsible node, resource utilization and a number of accesses of each of the plurality of nodes; and
if the resource utilization of a node exceeds a preset threshold so as to become an overloaded node, the responsible node executing a migration process to migrate out a part of the key-value pairs in the overloaded node.

16. The method according to claim 15, further comprising,
the responsible node calculating a number of I/O accesses to be migrated out from the overloaded node; selecting a target node, from the plurality of nodes other than the overloaded node, which can accommodate a largest number of I/O accesses from other nodes; and requesting the overloaded node to execute migration of a part of the key-value pairs to the target node in order to reduce the resource utilization to a level below the preset threshold; and
in response to the request from the responsible node to execute migration, in order to reduce the resource utilization to a level below the preset threshold:
determining a key range in the overloaded node to be migrated out based on the calculated number of I/O accesses to be migrated out from the overloaded node;
requesting the target node to create a virtual node, which is responsible for the key range to be migrated, in the target node; and
migrating key-value pairs in the determined key range to the target node.

17. The method according to claim 15, wherein the plurality of nodes are divided into a plurality of groups of multiple nodes, the method further comprising:
collecting, by the responsible node as a node in each group, resource utilization and a number of accesses of each of the multiple nodes in the group; and
if the resource utilization of all nodes in the group exceeds the preset threshold so as to become an overloaded group having overloaded nodes, the responsible node in the overloaded group executing a migration process to migrate out a part of the key-value pairs in at least one overloaded node in the overloaded group.

18. The method according to claim 17, further comprising the responsible node in the overloaded group:
calculating a number of I/O accesses to be migrated out from the overloaded group;
selecting a target group, from the plurality of groups other than the overloaded group, which can accommodate a largest number of I/O accesses from the overloaded group;
selecting the at least one overloaded node in the overloaded group;
determining a key range in each selected node of the selected at least one overloaded node to be migrated out based on the calculated number of I/O accesses to be migrated out from the overloaded group;
requesting the responsible node of the target group to create a DHT overlay of virtual nodes in target nodes in the target group which are responsible for the key range of each selected node to be migrated; and
requesting the selected at least one overloaded node to execute migration of a part of the key-value pairs to the target group in order to reduce the resource utilization of the overloaded group to a level below the preset threshold.

19. The method according to claim 18, further comprising, in response to a request from the group load balancing module of the responsible node in the overloaded group to create a DHT overlay, the responsible node of the target group:
determining a key range in each target node of the target group to receive key-value pairs to be migrated from the overloaded group based on the key range in the selected at least one overloaded node determined by the group load balancing module of the responsible node of the overloaded group; and
requesting each target node to create a virtual node, which is responsible for at least a portion of the key range of the selected at least one overloaded node to be migrated, in the target node.

20. The method according to claim 17, further comprising,
after executing the migration process to migrate out a part of the key-value pairs in at least one overloaded node in the overloaded group, rebalancing load among the plurality of nodes in the overloaded group by the responsible node in the overloaded group.
